(19) United States
(12) Patent Application Publication
(10) Pub. No.: US 2011/0258939 A1
(43) Pub. Date: Oct. 27, 2011

(54) METHODS FOR PRODUCING NANOPARTICLES HAVING HIGH DEFECT DENSITY AND USES THEREOF

(75) Inventors: Siu-Wai Chan, Demarest, NJ (US); Joan M. Raitano, Seaford, NY (US); Jenna Pike, Salt Lake City, UT (US)

(73) Assignee: The Trustees of Columbia University In The City of New York, New York, NY (US)

(21) Appl. No.: 13/087,211

(22) Filed: Apr. 14, 2011

Related U.S. Application Data
(63) Continuation of application No. PCT/US2009/060884, filed on Oct. 15, 2008.
(60) Provisional application No. 61/105,650, filed on Oct. 15, 2008.

(51) Int. Cl. C01F 1/00; C01B 31/20; C01F 17/00; H01M 8/06; B01J 23/83; C09K 3/14; B82Y 40/00

(52) U.S. Cl. 51/309; 502/304; 423/437.2; 429/420; 977/896

(57) ABSTRACT

The disclosed subject matter is directed to a method for producing nanoparticles, as well as the nanoparticles produced by this method. In one embodiment, the nanoparticles produced by the disclosed method have a high defect density. A solution including cerium nitrate hexahydrate is combined with a solution including hexamethylenetetramine to form a combined aqueous solution. After a period of time, the combined aqueous solution is combined with a solution including copper nitrate trihydrate to form a further aqueous solution. The further aqueous solution is then mixed to produce nanoparticles.

### CROSS-REFERENCE TO RELATED APPLICATIONS

This application claims priority to U.S. Provisional Application Ser. No. 61/105,650, filed Oct. 15, 2008, which is incorporated herein by reference in its entirety.

### STATEMENT REGARDING FEDERALLY SPONSORED RESEARCH OR DEVELOPMENT

This invention was made with government support under Award No. DMR-0213574 awarded by the National Science Foundation and Grant No. DOE DE-FG02-05ER15730 awarded by the Department of Energy. The government has certain rights in the invention.

### BACKGROUND

1. Technical Field

The disclosed subject matter is directed towards a process for producing nanoparticles having high defect density and uses of these nanoparticles.

2. Background Art

The water gas shift (WGS) reaction (H₂O+CO→H₂+CO₂) is an important reaction in hydrogen production and thus can be a critical component of future energy systems. Notably, hydrogen is the fuel in many fuel cell prototypes and the feedstock for many chemical processes. Nanoparticles are useful as catalysts of this reaction, and catalytic activity can be related to defect density of the nanoparticles. A high concentration of defects has been found to be an important characteristic of catalytically effective nanoparticles, especially for CO oxidation. This phenomenon can be explained by the fact that defect sites are important for gas adsorption, which is the first step in heterogeneous catalysis involving gas phase materials. Defect sites can also promote the adsorption of non-gas phase atoms, which is important because deposition-precipitation in which a catalytically active metal like gold is deposited on an oxide surface is a very common catalyst preparation method.

Current methods for producing nanoparticulate catalysts have various disadvantages. Some of the customary catalysts are pyrophoric and require slow and careful reduction, which is likely to be impractical for some energy needs, especially for fuel cells as they require numerous start-ups and shut-downs. Some methods to generate defects in crystals are expensive and difficult, including electronic bombardment, ion-implantation, ion-bombardment, or high-temperature annealing. These and other methods can involve either a high temperature process, which requires a large energy input, or a non-aqueous process, which increase costs in purchasing and disposing of organic solvents and reagents.

### SUMMARY

In one embodiment, the disclosed subject matter provides a method for producing nanoparticles, e.g., nanoparticles having a high defect density, where the method includes combining, e.g., mixing, a solution including cerium nitrate hexahydrate with a solution including hexamethylenetetramine to form a combined aqueous solution; mixing the combined aqueous solution with a solution including copper nitrate trihydrate to form a further aqueous solution; and mixing the further aqueous solution such that nanoparticles are produced. In one embodiment, the nanoparticles are collected from the further aqueous solution, e.g., via centrifugation or filtration.

In some embodiments, the further aqueous solution can be mixed for at least about 18 hours prior to collection of the nanoparticles. In other embodiments, the combined aqueous solution can be heated, e.g., to about 40° C. In still other embodiments, after the solution including copper nitrate trihydrate is added, the further aqueous solution can be further heated for about three hours.

In some embodiments, the cerium nitrate hexahydrate can have a concentration of about 0.0375M. In other embodiments, the hexamethylenetetramine can have a concentration of about 0.5M. In still other embodiments, the copper nitrate trihydrate can have a concentration of between about 0.004 and about 0.067M.

In some embodiments, the nanoparticles can be used in a redox reaction, e.g., a water-gas shift reaction, e.g., in a fuel cell. In other embodiments, the nanoparticles can be used for chemical mechanical planarization.

In another aspect, the disclosure provides a nanoparticle, e.g. a nanoparticle having high defect density, which is prepared by combining a solution including cerium nitrate hexahydrate and a solution including hexamethylenetetramine to form a combined aqueous solution, combining the combined aqueous solution with a solution including copper nitrate trihydrate to form a further aqueous solution, and mixing the further aqueous solution such that nanoparticles are produced. In one embodiment, the nanoparticles are collected from the further aqueous solution. In some embodiments, the copper content of the nanoparticles is above about 8%.

### BRIEF DESCRIPTION OF THE DRAWINGS

FIG. 1 illustrates an exemplary embodiment of the disclosed method for producing nanoparticles having extended defects.

FIG. 2 is a table listing particle sizes of nanoparticles having different copper contents, which were produced using an exemplary embodiment of the disclosed subject matter.

FIG. 3 shows Raman spectroscopy data comparing an uncalcined sample and a calcined sample heated to 400° C.

FIG. 4 illustrates an exemplary morphology exhibited by 8% Cu—CeO₂ catalyst produced using an exemplary embodiment of the disclosed subject matter.

FIG. 5 illustrates edge dislocation and continuity defects commonly found in nanoparticles produced using the disclosed subject matter.

FIG. 6 illustrates CO conversion data for Cu—CeO₂ catalysts. FIG. 6a illustrates CO conversion activity of parent (P) Cu—CeO₂ catalysts. FIG. 6b illustrates CO conversion in the remainder after pre-testing leach (R1). FIG. 6c illustrates the difference in CO conversion activity for parent and the corresponding remainder after pre-testing leach (P-R1).

FIG. 7 illustrates the experimental lattice parameter for the xCu—CeO₂ nanoparticles as a function of composition and a comparison with the calculated value for a substitutional solid with a copper content corresponding to that of FIG. 7a, parent (P), and FIG. 7b, remainder after pre-testing leach (R1) catalyst. For simplicity, both figures have been plotted with the parent content on the x-axis, but in FIG. 7b, the unleachable content is indicated next to each point.

FIG. 8 illustrates a nanoparticle of 8% Cu—CeO₂ catalyst showing extended defects: extra half plane between are as a and b and disconnected lattice planes between areas b and c. The 3.2 Å (approx.) between the planes is consistent with the spacing of the {111} planes in CeO₂ having a 5.417 Å lattice parameter.

FIG. 9 illustrates X-Ray Absorption Near Edge Structure (XANES) data at room temperature. FIG. 9a illustrates this data for a 8% Cu—CeO2 catalyst and the Cu oxidation state standards (i.e., Cu metal foil for Cu^{O} and micron powders of Cu₂O and CuO for Cu⁺ and Cu²⁺ respectively) at the Cu K edge. FIG. 9b illustrates this information for the first derivative of the catalyst and the standards' spectrums. Peaks 1, 2, and 3 in first derivative of the catalyst spectrum are indicative of the Cu2+ oxidation state.

FIG. 10 illustrates the room temperature x-ray diffraction (XRD) of xCu—CeO₂ catalysts (x=1.6 to 19.6, where x is the atomic % Cu), with the Miller indices indicated.

FIG. 11 illustrates the copper content in Cu—CeO₂ parent and catalyst remaining after the pre-testing leach.

FIG. 12 illustrates the experimental lattice parameters of the parent catalysts, % xCu—CeO₂ (x=1.6 to 19.6%) nanoparticles, as a function of composition, including both the absolute errors in the experimental values and the lattice parameter of bulk cerium oxide (the dotted line in the plot).

FIG. 13 summarizes the H₂-TPR results including reduction peak positions for the parent (P) catalyst and the catalyst remaining after pre-testing leach (R1) as well as H₂ consumption in the μmol/g catalyst.

FIG. 14 illustrates the H₂-TPR data of Cu—CeO₂ parent (P) and the catalyst remaining after pre-testing leach (R1): 20% H₂/80% N₂, 20 mL/min, 5° C./min. All compositions given are atomic percentages (at. %). A thicker line is used for the P data.

FIG. 15 illustrates the experimental H₂-TPR data below 200° C. FIG. 15a illustrates the total H₂ consumption by the parent (P) and that which remains after the pre-testing leach (R1). FIG. 15b illustrates the H₂ consumption per atomic % Cu (“normalized” by atomic % Cu) for P and R1. Note that the data is plotted as a function of the parent Cu content to facilitate comparison between the P and R1 data. However, the actual copper contents are listed next to the R1 data points.

FIG. 16 illustrates shows a comparison of the experimental H₂-TPR consumption and expected consumption based on copper stoichiometry. FIG. 16a illustrates the difference in H₂ consumption between the experiment and that expected for reduction of Cu²⁺ to Cu⁰ for P and R1. FIG. 16b illustrates the difference in H₂ consumption between the experiment and expectation per atomic % Cu. Note that the data is plotted as a function of the parent Cu content, but the actual copper contents are listed next to R1 data points.

FIG. 17 shows a comparison of CO conversion at a steady state of the parent (P) catalyst and the remainder after pre-testing leach (R1), each having roughly 6% copper: % conversion of 6.3% P and 6.0% R1.

FIG. 18 illustrates the rate (μmol/g catalyst) of CO conversion during an isothermal hold of 200° C. FIG. 18a shows the rate for the parent (P) and the catalyst remaining after pre-testing leach (R1). FIG. 18b shows the rate per atomic % Cu (“normalized”) of P and R1. To facilitate comparison, the data is plotted as a function of the original copper content of the parent catalyst, even though the R1 data have different copper contents. However, the actual R1 copper contents are indicated next to the corresponding points.

FIG. 19 shows XANES data at the Cu K edge. FIG. 19a shows the spectrum of copper oxidation state standards, fresh catalyst and used catalyst, both with (R1) and without pre-testing leaching (P). FIG. 19b shows the first derivative of the spectrum. The dotted lines show the position of the absorption edges for each of the standards.

FIG. 20 shows a comparison of copper contents in parent catalysts and the same samples after pre-testing leaching (for some) and subsequent post-testing leaching. FIG. 20a shows the comparison for 19.6% and 8.2% Cu—CeO₂ (parent, P) after pre-testing leaching (R1) and subsequent post-WGS leaching (R2). FIG. 20b shows the comparison for 8.2% Cu—CeO₂ (P) after pre-testing leaching (R1) and subsequent post-WGS OR post-TPR leaching (R2). FIG. 20c shows the comparison for 8.2% Cu—CeO₂ (P) after pre-testing leaching (R1) and subsequent post-WGS leaching OR after only post-WGS leaching (R2).

Throughout the drawings, the same reference numerals and characters, unless otherwise stated, are used to denote like features, elements, components or portions of the illustrated embodiments. Moreover, while the present disclosure will now be described in detail with reference to the Figures, it is done so in connection with the illustrative embodiments.

### DETAILED DESCRIPTION

The disclosed subject matter provides a method for producing nanoparticles. In one embodiment, the nanoparticles have a high defect density. The disclosed subject matter also provides nanoparticles produced by this method, and uses thereof. In one aspect, the method includes combining a solution comprising cerium nitrate hexahydrate with a solution comprising hexamethylenetetramine to form a combined aqueous solution, which is then combined with a solution comprising copper nitrate trihydrate, to form a further aqueous solution. The further aqueous solution is then mixed such that nanoparticles are produced.

Unless otherwise defined, all technical and scientific terms used herein have the same meanings as commonly understood by one of ordinary skill in the art to which the disclosed subject matter belongs. Although methods and materials similar or equivalent to those described herein can be used in its practice, suitable methods and materials are described below.

It is to be noted that the term “a” entity or “an” entity refers to one or more of that entity. As such, the terms “a”, “an”, “one or more”, and “at least one” can be used interchangeably herein. The terms “comprising,” “including,” and “having” can also be used interchangeably. In addition, the terms “amount” and “level” are also interchangeable and can be used to describe a concentration or a specific quantity. Furthermore, the term “selected from the group consisting of” refers to one or more members of the group in the list that follows, including mixtures (i.e. combinations) of two or more members.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to +/−20%, preferably up to +/−10%, more preferably up to +/−5%, and more preferably still up to +/−1% of a given value. Alternatively, the term can mean within an order of magnitude, preferably within 5-fold, and more preferably within 2-fold, of a value.

### Methodology

The present disclosure provides an aqueous method to produce nanoparticles, e.g. nanoparticles with a high defect density. The phrase “high defect density,” as used herein, can refer to a single particle having some imperfection or disruption in its crystal structure, such as an extended discontinuity, or more specifically, an edge dislocation. High defect densities are also described in Heun, S. et al. Journal of Vacuum Science & Technology B (Microelectronics and Nanometer Structures), 15(4), 1279-85 (1997), incorporated herein by reference.

“High defect density” can also refer to a composition comprising a percentage of particles having some imperfection or disruption in its crystal structure, such as an extended discontinuity, or more specifically, an edge dislocation. The percentage of defective particles can be proportional to the amount of copper cations present in the sample. For example, in one embodiment, in a composition comprising 8% Cu—CeO₂ particles produced by the methods of the invention, roughly 40% of the particles are defective with roughly 14% of the defects being edge dislocations.

The methods described herein allow for the preparation of nanoparticles having a high defect density at a low temperature. Therefore, the process does not require a large energy input. Furthermore, because the procedure is completely aqueous based, the costs of purchasing and disposing of organic solvents are avoided. Therefore, the disclosed methods are highly efficient and cost effective and do not require expensive equipment.

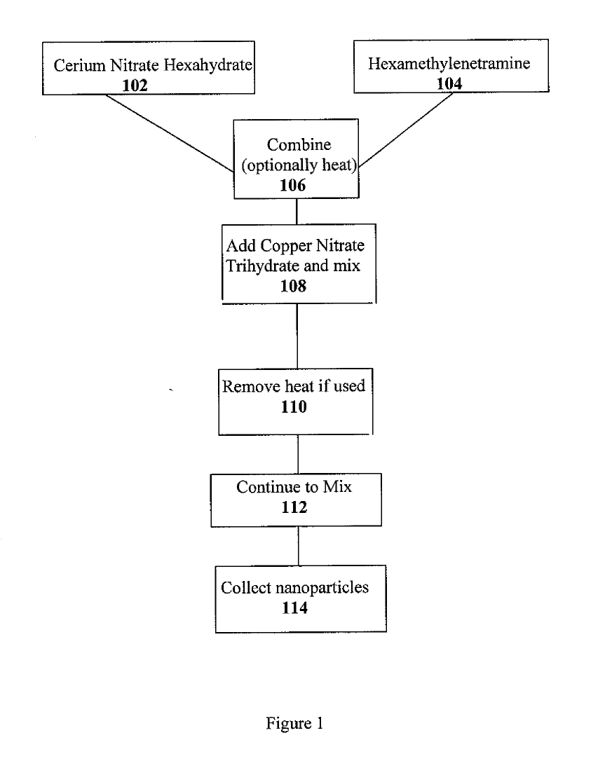

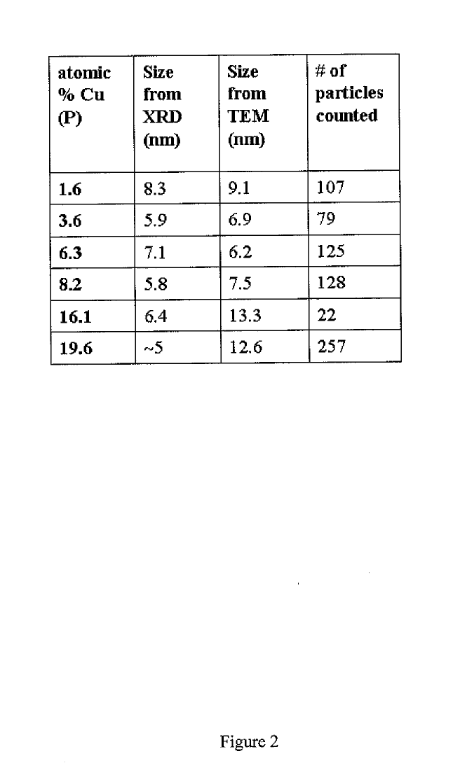

FIG. 1 illustrates an exemplary embodiment of the process for producing the high defect density nanoparticles of the disclosure, which involves first providing two precursor aqueous solutions. In the embodiment described in FIG. 1, the first aqueous solution comprises cerium nitrate hexahydrate (Ce(NO₃)₃-6H₂O) and the second aqueous solution comprises hexamethylenetetramine (HMT). In addition, a third aqueous solution is added to the precursor solution, which comprises copper nitrate trihydrate. However, the use of these specific aqueous solutions in the methods of this disclosure is not meant to be limiting. The resulting nanoparticles can be composed of an oxide support and an active metal or metal oxide. For example, in the exemplary embodiment described in FIG. 1, the resulting nanoparticles will be copper ceria nanoparticles which include an oxide support, cerium oxide, and an active metal oxide, copper oxide. In one embodiment, most of the nanoparticles produced by the methods of the invention will not have a rod-like shape that is consistent with pure, monoclinic copper oxide (Pike, J.; Chan, S.-W.; Zhang, F.; Wang, X.; Hanson, J; Applied Catalysis A: General, 303(2), 273-277 (2006)). For example, of the hundreds of particles examined in connection with FIG. 2, fewer than ten had a morphology consistent with pure copper oxide. Rather, the morphology is consistent with that of cerium oxide (Zhang, F.; Jin, Q.; Chan, S.-W.; Journal of Applied Physics, 95(8), 4319-4326 (2004)).

In 102 and 104 of FIG. 1, the first aqueous solution and the second aqueous solution are provided. In one embodiment, these aqueous solutions are mixed separately. For example, the solutions can be mechanically stirred. In another embodiment, the solutions can be mixed at room temperature. In one embodiment, the first aqueous solution can comprise a cerium nitrate hexahydrate (Ce(NO₃)₃-6H₂O) solution and the second aqueous solution can comprise a hexamethylenetetramine (HMT) solution.

In one embodiment, the cerium nitrate hexahydrate solution can have a concentration of about 0.0375 M. In other embodiments, the cerium nitrate hexahydrate solution can have different concentrations. For example, the solution can have a concentration as low as approximately 0.005M. However, based on previous studies on different systems, but involving aqueous synthesis with HMT, the use of low concentrations could result in a smaller particle size (Lu, C.-H.; Raitano, J. M.; Khalid, S.; Zhang, L.; Chan, S.-W.; Journal of Applied Physics, 103(12) (2008)). The concentration of the cerium nitrate hexahydrate solution can also be as high as approximately 0.5M. Therefore, the cerium nitrate solution can range in concentration between approximately 0.005M to approximately 0.5M.

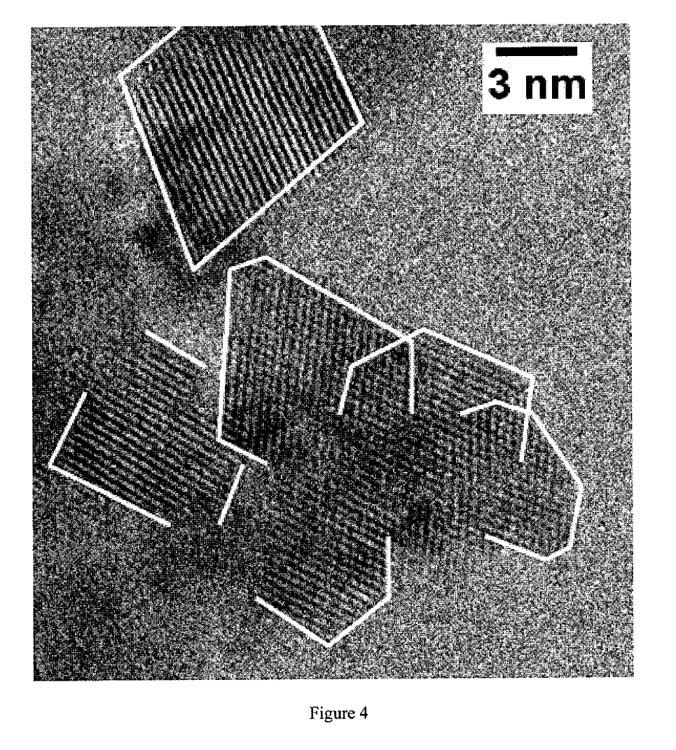

In another embodiment, the HMT solution can have a concentration of about 0.5M. The concentration of the HMT solution can also be as low as approximately 0.1M, or as high as approximately 2.8M. Experimental results indicate that high HMT concentrations can result in near quantitative yields. Therefore, the HMT can range in concentration between approximately 0.1M to approximately 2.8M. However, higher concentrations can alter the morphology from the octahedrons seen in FIG. 4, to more rounded nanoparticles.

The two solutions can be mixed separately, e.g., for a period of approximately 15, 20, 25, 30, 35, 40, or 45 minutes. The solutions can also be mixed for longer periods of time, such as approximately 50, 60, 70, 80, 90, 100, 110 or 120 minutes. The pH value of the HMT solution remains fairly constant over a range of time, e.g., whether the solution is mixed for 30 or 120 minutes, for example. This remains true over a range of HMT concentrations from, for example, about 0.5 m to about 2.5 m. In an exemplary embodiment, the two solutions are mixed for approximately 30-35 minutes.

In an exemplary embodiment of the process as described in FIG. 1, cerium oxide will be the oxide support based on the use of the cerium nitrate hexahydrate solution. Other oxide supports can include but are not limited to, zinc oxide, zirconium oxide, and a mixed oxide of cerium and zirconium oxides.

The first and second aqueous solutions are then combined to form a combined aqueous solution at 106. In one embodiment, the combined aqueous solution is mixed for some period of time, e.g., approximately 15-20 minutes, and then, optionally, the combined aqueous solution is heated. The solution can be heated by adding the combined aqueous solution to a heated reaction vessel, such as, for example, a water-jacketed beaker heated with a NesLab EX Series bath/circulator. The combined aqueous solution can also be heated by any method known in the art, e.g., by heating in a water bath. In an exemplary embodiment, the combined aqueous solution is heated to approximately 40° Celsius. The solution can also be mixed at other temperatures, including any temperature between room temperature and about 85° C. or even about 100° C.

A third aqueous solution can then be added to the combined aqueous solution (e.g., while heating) to form a further aqueous solution at 108. In one embodiment, the third aqueous solution is added quickly to the combined aqueous solution. The third aqueous solution can be a solution comprising copper nitrate trihydrate (Cu(NO₃)₂) 3H₂O or other hydrates or anhydrous forms of Cu(NO₃)₂. In one embodiment, the copper nitrate trihydrate can have a concentration of between about 0.004 and about 0.067M. In another embodiment, the copper nitrate trihydrate can have a concentration of between about 0.004M and about 0.140M. Generally, the third solution can include a solution of metal cations that can produce a metal or metal oxide with a high density of states near the Fermi level, such that it can give and receive electrons easily, such as, for example, platinum (Somorjai, G. A.; Park, J. Y.; Physics Today, 60(10), 48-53 (2007)), or a material with multiple oxidation states, such as, for example, iron, copper, or manganese. Materials containing copper and manganese can also be used, because they can easily change oxidation states depending on the gaseous environment and heating (Pike, J.; Hanson, J.; Zhang, L.; Chan, S.-W.; Chemistry of Materials, 19(23), 5609-5616 (2006); Pike, Chan et al. (2006)).

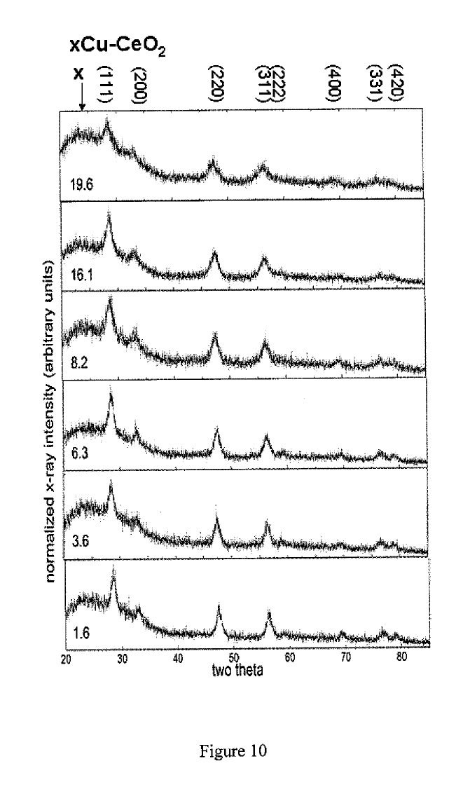

The third aqueous solution can be added after the heat source is applied, e.g., approximately 10-15 minutes after the heat source is applied, or, in the absence of a heat source, after the completion of the mixing of the combined aqueous solution. In one embodiment, the third aqueous solution (Cu(NO₃)₂) can be added without heating the combined aqueous solution, or any time after the removal of heat, which can result in slight changes in the properties of the nanoparticles. For example, without wishing to be bound by any theory or mechanism, if the nanoparticulate sample is used directly after precipitation (i.e., without subsequent heat treatment), the time of addition can affect whether Cu—CeO₂ better approximates a solid solution or whether more of a core-shell morphology develops. That is, if the Cu(NO₃)₂ is added well after the ceria has nucleated and started to grow, most of the copper product will likely lie outside a pure ceria shell and without heating will remain as such. With such a core-shell morphology, copper or copper oxide peaks can be observed, since the copper is on the nanoparticle surface in this scenario. Such peaks are not seen in any of the XRD data of samples calcined at 400° C. in FIG. 10 or the XRD of the uncalcined 8% Cu—CeO₂, but with a copper content this low, such peaks may or may not be visible above the noise level, depending on the broadness (full-width at half-maximum) of the peaks. Heating to higher temperatures, such as, for example, 800° C., with a sample prepared as in Example 1, clearly results in separation of the phases, which could be seen as separate CeO₂ and CuO XRD peaks, even with copper contents as low as 8%.

The concentration of the third aqueous solution can be adjusted to increase or decrease the active metal/metal oxide content of the nanoparticulate product. For example, a copper nitrate trihydrate solution between about 0.004 and about 0.067M produces a cerium oxide having a final copper content of approximately 1.6%-19.6% based on the total amount of copper and cerium, as determined by inductively-coupled plasma (ICP). In an exemplary embodiment of the process as described in FIG. 1, copper will be the active metal oxide based on the use of copper nitrate trihydrate as the third aqueous solution.

If a heat source was applied, the heat source is removed after a certain period of time at 110. In an exemplary embodiment, the heat is removed approximately 3 hours after the third aqueous solution is added and mixing can be continued. In one embodiment, heat is maintained for a longer period of time, resulting in a higher yield in a shorter amount of time.

The reaction is then allowed to continue to mix for another period of time at 112. The further aqueous solution can be stirred in order to mix the solution, or mixed by any method known in the art. The period of time can be approximately 18, 19, 20, 21, 22, 23, 24 or more hours after the heat source is removed, or, if no heat source was applied, approximately 21, 22, 23, 24 or more hours after the third aqueous solution was added. In general, the further aqueous solution must be mixed for more than four hours in order to obtain a reasonable yield. For example, experimental results indicate that the yield can be 60% or higher in both cerium oxide and copper oxide after 22 hours of mixing. Longer mixing times may improve the yield, but will likely not impact the particle size.

In an optional embodiment, the nanoparticulate product is then collected from the further aqueous solution at 114. The product can be collected by any method known in the art, including but not limited to, centrifugation or filtration. Centrifugation can be accomplished by any method and with any tools known in the art, including, but not limited to, a Sorvall RC5B or RC5B+, operating around 12,000 rpm or higher. The time required for separation by centrifugation will be known by one of ordinary skill in the art, and is readily calculated from standard centrifugation equations for separating particles from a liquid suspension. Filtration can also be accomplished by any method or with any tools known in the art, including, but not limited to, submicron filter papers. Filtration can occur without the addition of any flocculating agents.

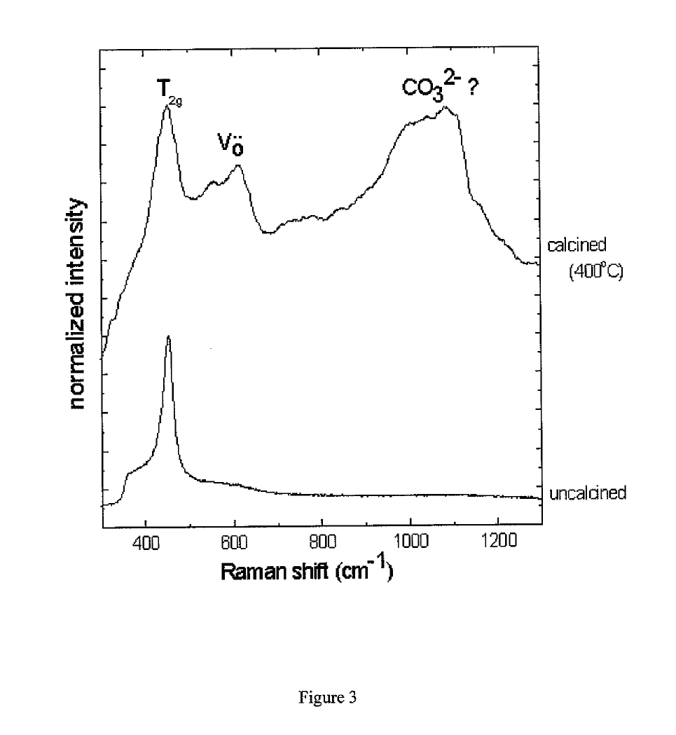

After the nanoparticulate product is collected, it can be allowed to dry in the air and, in one embodiment, ground with a mortar and pestle. The nanoparticulate product can then be calcined or annealed at approximately 400° C. for approximately four hours. The calcination step can have a large effect on the properties of the nanoparticles, as illustrated by the change in the Raman data after heating the sample at 400° C. in FIG. 3. Higher calcination temperatures, such as 800° C., result in phase separation.

### Nanoparticulate Product

The nanoparticulate product described in relation to FIG. 1 can be approximately 5-14 nm in diameter. However, the size of the nanoparticulate product can be affected by many factors, including the solutions used as reactants, the concentrations of the reactants, and the ratio of the cation concentration to the HMT concentration. As an example, FIG. 2 illustrates the particle size of Cu—CeO₂ nanoparticles which were produced using an embodiment of the disclosed subject matter. The particle size was determined by TEM measurements and by application of the Scherrer equation to X-ray diffraction (XRD) data.

Pure Ce—O₂ is relatively defect free and consists of particles that are octahedrons or truncated octahedrons (Zhang, F., Jin, Q., Chan, S.-W., Journal of Applied Physics 95, 4319-4326 (2004)). However, Cu—CeO₂ has a non-negligible defect density. Likewise, the high defect density nanoparticles can be characterized by an octahedral or truncated octahedral morphology. FIG. 4 illustrates a nanoparticle which has octahedral or truncated octahedral morphology. More specifically, FIG. 4 illustrates the morphology of an 8% Cu—CeO₂ catalyst which was produced using the disclosed subject matter.

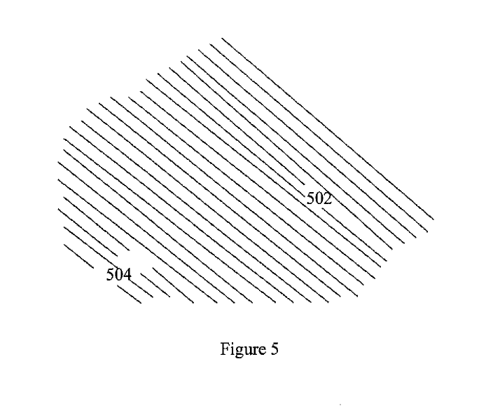

At least some of the nanoparticles produced using the methods of the disclosure include extended defects. Defects can also include edge dislocation and discontinuous lattice planes (discontinuity). FIG. 5 illustrates both an edge dislocation 502 and a discontinuity 504.

### Uses for the Nanoparticles

The nanoparticles produced using the disclosed subject matter can be used for any application in which nanoparticles with significant extended defects or a high defect density are useful. For example, the nanoparticles can be used as catalysts in redox reactions. These redox reactions can include, but are not limited to, CO oxidation, steam reforming of methanol, and automobile pollution abatement: three-way catalysis.

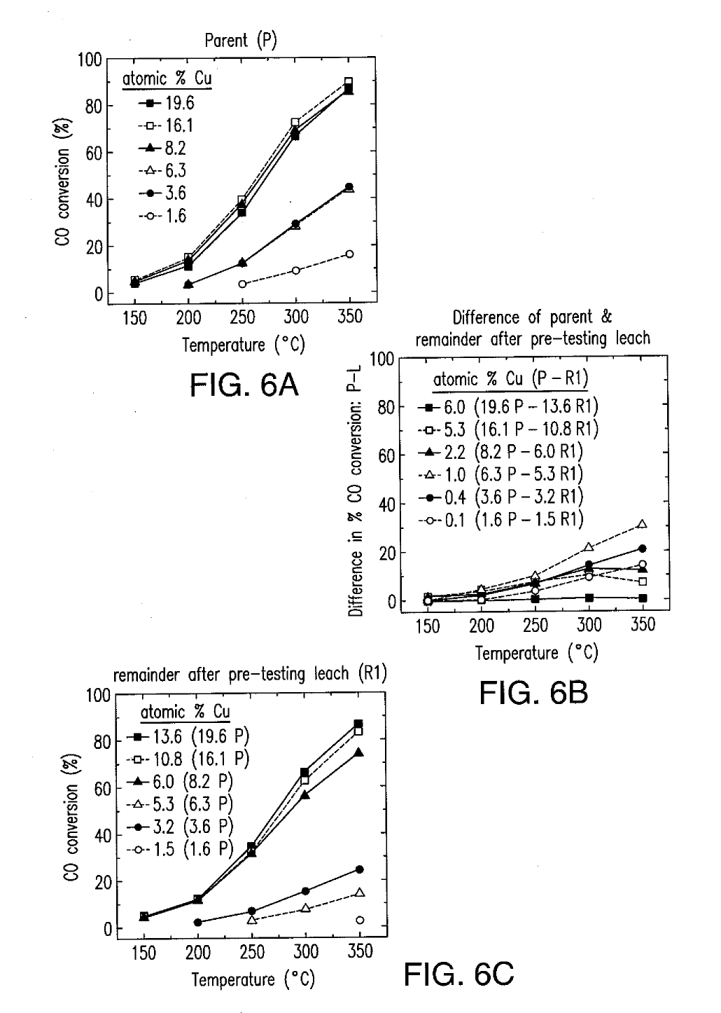

The nanoparticles can be used as a catalyst in the water-gas shift reaction (WGS), which is also a redox reaction. In an exemplary embodiment of the process, the nanoparticles have a critical copper content for catalysis in the WGS reaction of approximately 8% or above, e.g., approximately 9%, 10%, 11%, 12%, 13%, 14%, 15%, 16%, 17%, 18%, 19%, or 20%. FIG. 5 illustrates activity data, or more particularly CO conversion activity, for Cu—CeO₂ catalysts. Six catalysts with different copper content are shown and were produced by the disclosed subject matter. As shown in FIG. 6, of the Cu—CeO₂ catalysts tested, CO conversion activity was highest in the catalysts having approximately 8% Cu, 16% Cu, and 19% Cu (approximately 90% at 350° C.).

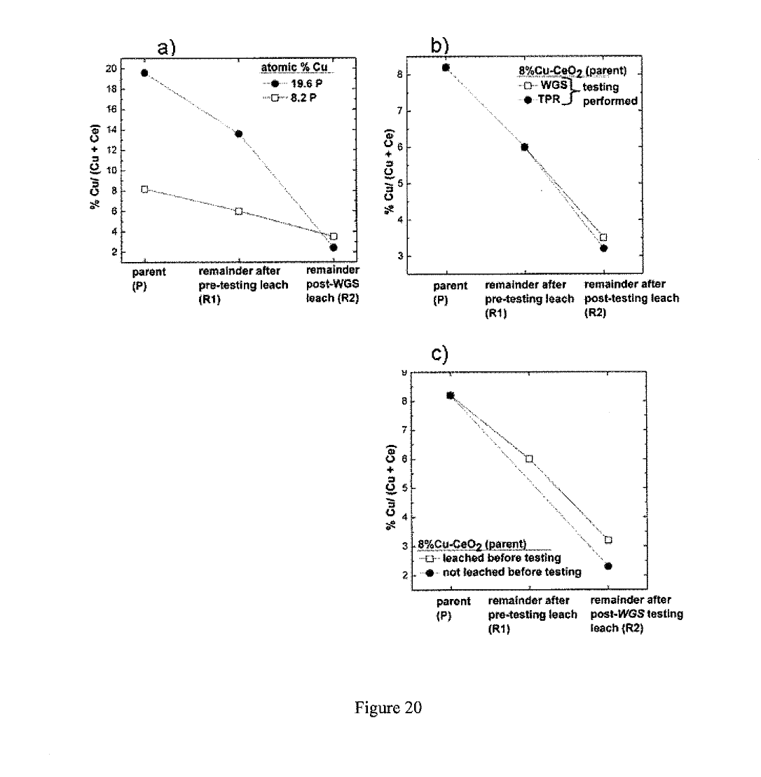

The nanoparticles can also be used for applications in which they can function other than as catalysts for a reaction. Ceria particles can be of interest for use in slurries for chemical mechanical planarization. For example, ceria-based slurries can be used both front-of-the-line (e.g., Shallow Trench Isolation (STI)) as well as back-of-the-line (e.g., Inner Layer Dielectric (ILD) or copper polishing) (Merricks, D., Her, B., Santorea, B. Ferro Electric Material Systems: Penn Yan, N.Y. (2005)). Copper or copper oxide content in ceria particles can be beneficial. For example, the ability to incorporate a large amount of copper ions can be beneficial. Also, reusable slurries can be made, as the copper content can be reduced after use by heating the nanoparticles. Such heating causes the copper content to be easily leachable by aqueous sodium cyanide solutions as has been seen in FIG. 20. Without wishing to be bound by any theory or mechanism, the improved leachability is likely the result of diffusion of copper oxide to the nanoparticle surface.

### EXAMPLES

The disclosed subject matter will be better understood with reference to the following Examples, which are provided as exemplary of the disclosed subject matter, and not by way of limitation.

### Example 1

### Co-Precipitation of Cu—CeO2 with Extended Defects Experimental

In the present example, to synthesize the catalyst, 400 mL of a 0.0375M aqueous solution of cerium (III) nitrate hexahydrate [Ce(NO₃)₃.6H₂O] (99.5%) and 400 mL of a 0.5M aqueous solution of hexamethylenetetramine [(CH₂)₆N₄, HMT] (>99%) were prepared and allowed to mix for 30 minutes separately at room temperature. The two solutions were subsequently combined, and after mixing for an additional 15 minutes, the reactants were heated to 40° C. in a water bath. About 10 minutes later, a 0.065M solution of Cu(NO₃)₂.2H₂O (25 mL) was quickly added to the mixture. After 3 hours of heating (from the introduction of the Cu-salt), the water bath was turned off and the reaction allowed to mix for an additional 18 hours. The product was collected by filtration with submicron filter paper or centrifugation and the dark green powder was annealed for 4 hours at 400° C. The copper content was determined by inductively coupled plasma-atomic emission spectrometry (ICP-AES).

X-ray diffraction (XRD) was collected with a Scintag diffractometer set to −45 kV and 35 mA. The data was converted from text to a .cpi file with ConvX (Bowden, M. ConvX software (1998)) the peaks were fit with Xfit (Cheary, R. W. C., A. A, deposited in CCP14 Powder Diffraction Library, Engineering and Physical Sciences Research Council, Daresbury Laboratory, Warrington, England, http://www.ccp14.ac.uk/tutorial/xfit-95/xfit.htm (1996)) and the lattice parameter was calculated with Celref (b.J.1.a.B.B., ENSP/Labatoire des Materiaux et du Genie Physique, BP 46. 38042 Saint Martin d'Heres, France, http://www.inpg.fr/LMPG and http://www.ccp14.ac.uk/tutorial/1mpg (No Year Given)).

### Results

Transmission electron microscope (TEM) images were taken with a Jeol JEM-100CX operating at 100 kV and size measurements were made with ImageJ software (Rasband, W. S., U.S, National Institutes of Health, Bethesda, Md., U., http://rsb.info.nih.gov/ij (1997-2005)). High resolution transmission electron microscopy (HRTEM) images were taken at Center for Functional Nanomaterials (CFN) at BNL using a JEOL 3000F TEM/STEM operating at 300 kV or a Jeol JAM2100F operating at 200 kV.

Leaching the xCu—CeO₂ (where x is the atomic percent) nanoparticles with NaCN could only remove a fraction of the copper as measured by ICP-AES. Furthermore, even though the presence of Cu has been verified, XRD shows only the characteristic peaks of cubic fluorite CeO₂ (ceria). That is, Cu, Cu₂O, and CuO characteristic XRD peaks are not observed.

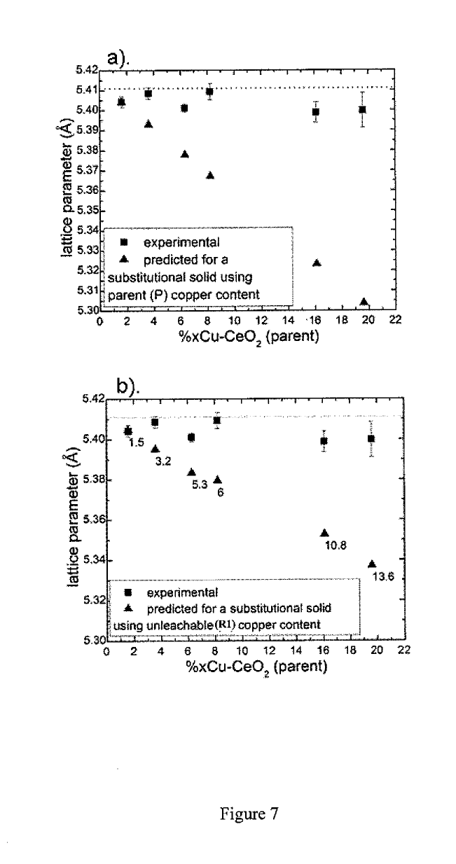

In the XRD data, the ceria peaks are slightly shifted to higher 2θ, relative to the same peaks of pure ceria nanoparticles of the same size (Zhang, F., et al., Applied Physics Letters 80, 127-9 (2002)), but the lattice parameter (aₒ) remain fairly constant as a function of composition (FIG. 6). The expected lattice parameter was calculated with an equation for the lattice parameter of a substitutional solid (Kim, D.-J., Journal of the American Ceramic Society 72, 1415-21 (1989)) assuming Ce⁴⁺ and Cu²⁺ radii of radius of 0.97 Å and 0.73 Å, respectively (Shannon, R. D. Acta Crystallographica, Section A A32, 751-67 (1976)). In one method, the parent copper content was used (FIG. 6a). In the other method, the unleachable copper content (R1) was used (FIG. 7b). In general, the fit is somewhat better with the second method and is best at the low copper contents. Copper could be segregated to the center of the discontinuities or defects, or it could exist as separate domains in the CeO₂ nanoparticles.

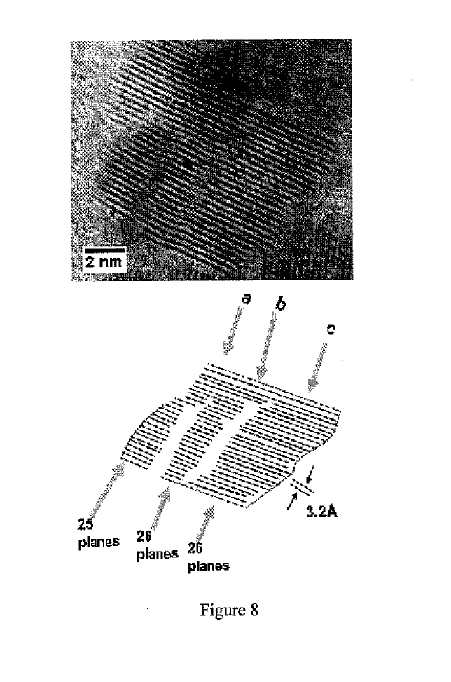

High resolution transmission electron microscopy of the 8% Cu—CeO₂ sample shows that the nanoparticles exhibit both the octahedral and truncated octahedral morphology of pure ceria nanoparticles (FIG. 4). The plane spacing observed is consistent with the planes parallel to the eight {111} surfaces of an octahedron (Zhang, F., Jin, Q., Chan, S.-W., Journal of Applied Physics 95, 4319-4326 (2004)). The average particle size, for the 8% Cu—CeO₂ as observed in TEM, 8 nm, is consistent with the calculation based on XRD peak broadening (Zhang, et al. (2002)). The particles were also characterized by extended defects such as edge dislocations indicated by an extra plane of atoms (FIG. 8).

After annealing, a substantial vacancy concentration can be inferred based on Raman data. The Raman data is illustrated in FIG. 3, showing that the annealing treatment brings about substantial changes in the sample and likely increases the solid solution character of the sample. Thus, the calcinations of the sample is likely a critical factor in the final properties the sample exhibits. It has been postulated that such vacancies are very important in the WGS (Wang, X.; Rodriguez, J. A.; Hanson, J. C.; Gamarra, D.; Martinez-Arias, A.; Fernández-Garcia, M.; Journal of Physical Chemistry B, 110(1), 428-434 (2006)).

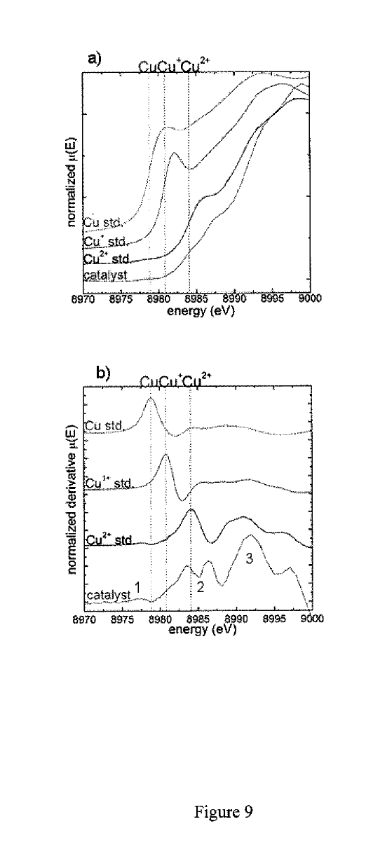

Data taken at the Cu K edge for the 8% Cu—CeO₂ catalyst and the standards for the Cu oxidation states of 0, 1, and 2 are shown in FIG. 9a. The positions of the absorption edges for each of the Cu oxidation state standards (i.e., copper metal foil, micron Cu₂O, and micron CuO) are shown as dotted lines in the plot. FIG. 9b shows the first derivatives of the spectra which are used to determine the absorption edges. Comparison of the 8% Cu—CeO₂ spectrum with these standards indicates that the catalyst is most similar in its first derivative to the Cu²⁺ standard with its absorption edge at approximately 8985 eV (FIG. 9b). The catalyst also exhibits the same double peak pattern in its first derivative as the Cu²⁺ standard, with one peak (labeled “2” in FIG. 9b), centered at about 8985 eV and a second at 8992 eV (labeled “3”). Moreover, the 8% Cu—CeO₂ also shows the pre-edge peak at 8977 eV in its first derivative characteristic of the +2 oxidation state (Berry, A. J., Hack, A. C., Mavrogenes, J. A., Newville, M., Sutton, S. R., American Mineralogist 91, 1773-1782 (2006)). However, the catalyst in this study exhibits a split peak at 8985 eV, and there is a shoulder on the lower energy side of peak “a” which is in between the edge positions of the +1 and +2 standards, therefore, a small fraction of the copper cations can be in a slightly lower oxidation state.

### Discussion

The calculation of the expected lattice parameter for a substitutional solid is carried out using two different copper contents: the parent (P) or the remainder after pre-testing leach (R1). The calculation using the parent value assumes that all the copper in the nanoparticle is in solid solution with ceria. The calculation using the unleachable value assumes that the unleachable copper (copper remaining after the pre-testing leach or R1) is in solid solution with ceria and the leachable copper perhaps exists as nanoparticles or clusters on the surface of ceria. While the depression of the lattice parameter with respect to pure nano-ceria (Zhang et al.(2002)) is consistent with the Cu—CeO₂ sample having some solid solution character as Cu²⁺ ions have a smaller radius than Ce⁴⁺ and the latter method using the unleachable copper content is closer to experimental values, the fit between theory and experiment is only good for the lowest copper content samples.

However, as indicated above, there are no XRD peaks consistent with copper or copper oxides species. Moreover, fewer than 2% of the over 700 particles examined were observed by TEM to have the rod-like morphology of copper (II) oxide, where XANES results indicate that copper is in the +2 oxidation state at room temperature. Therefore, the incorporation of copper ions into the ceria lattice with this method appears to be successful as has been reported elsewhere (Lamonier et al. (1999); Tschope, A. et al. Journal of Physical Chemistry B 103(42), 8858, (1999); Bera, P. et al. Chemistry of Materials, 14(8), 3591, (2002)), but it is unclear if this copper oxide forms a partial solid solution while the remainder exists as clusters inside the ceria lattice or perhaps is amorphous.

The defective microstructure evident in the HRTEM image of FIG. 8, which is not found in the near-perfect single crystals of pure ceria nanoparticles (Zhang et al.(2002)), is also in agreement with the co-existence of the unequally sized Ce⁴⁺ and Cu²⁺ ions in the same cation sublattice. As mentioned above, room-temperature XANES has been used to confirm the oxidation state of copper (FIG. 9) as well as cerium, where the presence of a small fraction of Ce³⁺, which is a larger than the Ce⁴⁺ cation (In CRC Handbook of Chemistry and Physics, 88th Ed.; Lide, D. R., 2007-2008) would only increase the dispersion in cation radii. Furthermore, the general absence of any copper oxide species in TEM suggests that copper is either well dispersed (Gamarra, D. et al. J. of Physical Chemistry C, 111(29), 11026-38 (2007)) or in the lattice, as a solid solution or as clusters. Similarly, a study in which a non-negligible strain was measured for the 8% Cu—CeO₂ sample under WGS conditions, but at room temperature (Raitano, J., et al. In Situ Study of the Relationship between Inhomogeneous Strain and Catalytic Activity in Cu—CeO₂ Water Gas Shift Catalysis. In Columbia University: New York, 2009), suggests that copper is incorporated into the ceria nanoparticles. Ceria nanoparticles of copper cation content of 2-20% have been prepared by a low temperature aqueous process with the same average crystallite-size of approximately 6-13 nm. Only peaks corresponding to cubic ceria were observed in x-ray diffraction (XRD). No extraneous phases of Cu, Cu₂O or CuO were observed in XRD or in transmission electron microscopy prior to catalytic testing. The nanoparticulate product exhibits solid solution characteristics based on high resolution transmission electron microscopy (HRTEM), x-ray diffraction (XRD) data and Rama data.

### Example 2

### Cu—CeO2 Nanoparticles: Critical Copper Contents for the Water-Gas Shift Reaction and the Dynamic Nature of the Copper Species Experimental

The Cu—CeO₂ catalysts were prepared as follows. First aqueous solutions of Ce(NO₃)₃.6H₂O (99.5%) and HMT (>99%) were mechanically stirred separately for roughly 30 minutes and then combined. After 20 minutes, the mixture was added to a water-jacketed beaker heated with a Neslab EX Series bath/circulator and allowed to mix for another 10-15 minutes before a Cu(NO₃)₂.3H₂O solution was added. All chemicals were obtained from Alfa Aesar (Ward Hill, Mass.) and used without further purification. The Cu(NO₃)₂.3H₂O used in this experiment has since been relabeled as Cu(NO₃)₂.2.5H₂O. The concentration of the Cu(NO₃)₂ solution was varied to prepare nanoparticles with different Cu/(Cu+Ce) ratios.

After 3 hours mixing above room temperature, the heater was turned off. The mixture slowly returned to room temperature over the course of about 2 hours and was stirred for another 18 hours from the time the heater was shut off. The product was collected either by centrifugation, with a Sorvall RC5B or RC5B+ operating around 12,000 rpm, or filtration without the addition of any flocculating agents. The former method was preferred, because after the first few seconds of filtration, the process slowed down greatly, likely the result of the nanoparticles or their aggregates clogging the filter membrane's submicron pores. The product was allowed to dry in air, ground with a mortar and pestle, and calcined at 400° C. for 4 hrs, with temperature ramps up and down at rates of 2° C./min and −2° C./min, respectively.

Before catalytic testing, a portion of each of the samples was leached with a 2% (by weight) sodium cyanide solution (NaCN) maintained above pH 12 in order to prevent the formation of poisonous hydrogen cyanide (HCN) gas. Additional leaching of select used catalysts (after WGS and temperature-programmed reduction testing) was performed as well. The composition before and after leaching was determined by ion-coupled plasma (ICP)— atomic emission spectroscopy (AES).

Particle size, size distribution, microstructure, and diffraction patterns were studied using Jeal 100CX, 300, and 2100F instruments operating at 100, 300, and 200 kV, respectively. The latter two instruments were used at Brookhaven's Center for Functional Nanomaterials (CFN).

Temperature-programmed reduction with hydrogen gas (H₂-TPR) was conducted with a Micromeritics Pulse Chemisorb 2705 system coupled with a thermal conductivity detector (TCD). As a pretreatment, the samples were heated in 20% O₂/He at 350° C. for 30 min. After cooling down, the samples then were heated at a rate of 5° C./min to 400° C. in 20% H₂/80% N₂ flowing at 20 mL/min, while TPR data were collected. After the maximum temperature was reached, the samples were cooled down in helium.

Water-gas shift activity testing was conducted on 0.1 g samples. The gas composition was 2% CO/10% H₂O/He, and the flow rate was 70 mL/min. After testing, the samples were cooled down in a CO/He atmosphere and then purged in He for hours.

Before and after annealing, before and after leaching, and before and after catalytic testing, samples were studied by x-ray diffraction (XRD). Cu Kₐ₁ radiation was employed from a Scintag X₂ x-ray diffractometer operating at −45 kV and 35 mA (used before catalytic testing) and from a Philips)(Pert XRD operating at 40 kV and 30 mA (used after catalytic testing). Data were processed as described above in relation to Example 1.

X-ray absorption near edge spectroscopy scans were collected at beamline X19A at BNL's NSLS. Spectra were taken at the Cu K edge in fluorescence mode with the Si(111) monochromator was detuned about 30% and a monochromator step size of 0.1-0.2 eV was used near the absorption edges. Bulk copper (II) oxide, copper (I) oxide, and a metal sheet were used as the Cu²⁺, Cu¹⁺, and Cu^{o} standards, respectively. Spectra were processed as described herein.

### Results

From here forward, the as-prepared catalyst will be referred to as the “parent” (P) and the copper present in the catalyst after the pre-testing leach will be indicated as “initial remainder” (R1). The composition of the final products will be denoted as x % Cu—CeO₂ (where x<20 for all samples studied and x %=mol_{Cu}/(mol_{Cu}+mol_{Ce})).

Moreover, describing the nanoparticles in this study as Cu—CeO₂ is not meant to imply anything regarding the oxidation state of the copper in the catalysts. This is simply the common way of referring to such materials.

The diameter of the as-prepared Cu—CeO₂ nanoparticles ranged from 6 to 13 nm as determined by TEM, as shown in FIG. 2. The sizes determined by applying the Scherrer equation to XRD data are in good agreement with the TEM data except for the two highest copper contents (16.0 and 19.6 atomic % copper). For those compositions, the TEM size was larger than the XRD size.

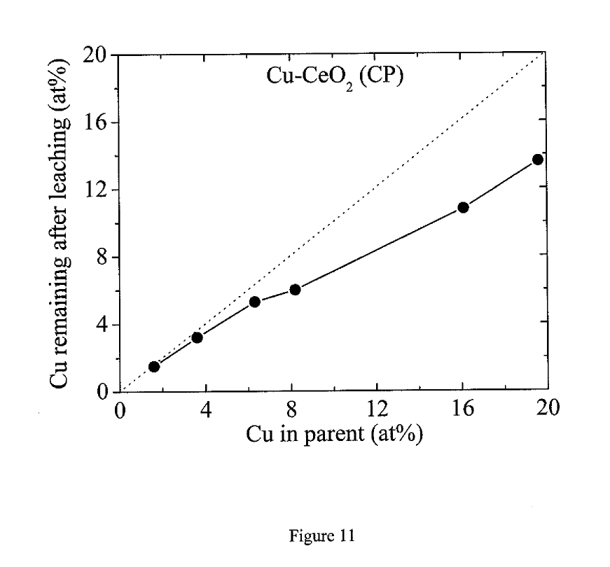

High resolution transmission electron microscopy (1-IRTEM) of the system has shown only particle morphologies consistent with cerium oxide (FIG. 4), including octahedrons and truncated octahedrons, rather than morphologies consistent with copper (II) oxide (Pike, Chan et al. (2006)), in spite of the fact that XANES data, indicate that copper is in the 2+ state in these catalysts at room temperature. Likewise, x-ray diffraction (XRD) revealed only peaks characteristic of cerium oxide (FIG. 10) in all the as-prepared Cu—CeO₂ catalysts. (In FIG. 10, note that all samples exhibit the characteristic XRD pattern of CeO₂ (Miller indices indicated), albeit shifted to slightly higher angles, but do not show signs of copper species). However, the microstructure of these nanoparticles is defective (FIG. 8), including edge dislocations and other lattice discontinuities, which is unlike pure nano-CeO₂ prepared using a similar procedure (Zhang, F., Jin, Q., Chan, S.-W., Journal of Applied Physics 95, 4319-4326 (2004)). Moreover, leaching of these as-prepared, catalysts with sodium cyanide (NaCN) could remove some, but not all of the copper content, as measured by ICP-AES (FIG. 11).

Thus, the phase purity of the XRD data, the morphology observed in HRTEM, the defective microstructure, and the inability to leach all of the copper from the nanoparticles suggests the formation of, at least, a partial solid solution between two ions of dissimilar radii (Ce⁴⁺ and Cu²⁺ radii of radius of 0.97 Å and 0.73 Å, respectively) (Shannon (1976)).

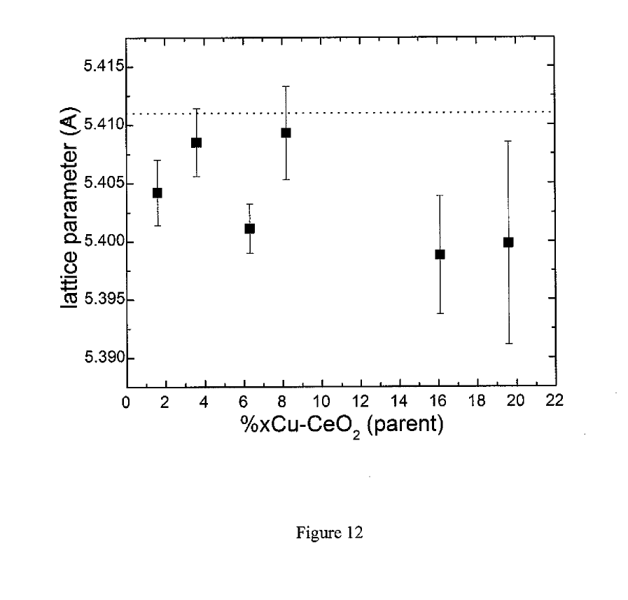

Yet the lattice parameter (a₀) determined from the XRD data is fairly constant as copper content increases (FIG. 12), although a progressive depression in the CeO₂ lattice parameter is expected (Vegard, L., Zeitschrift fur Physik, 5(1), 17-26 (1921)) given the radii above. That is the lattice of ceria should contract as increasing amounts of copper is added to it.

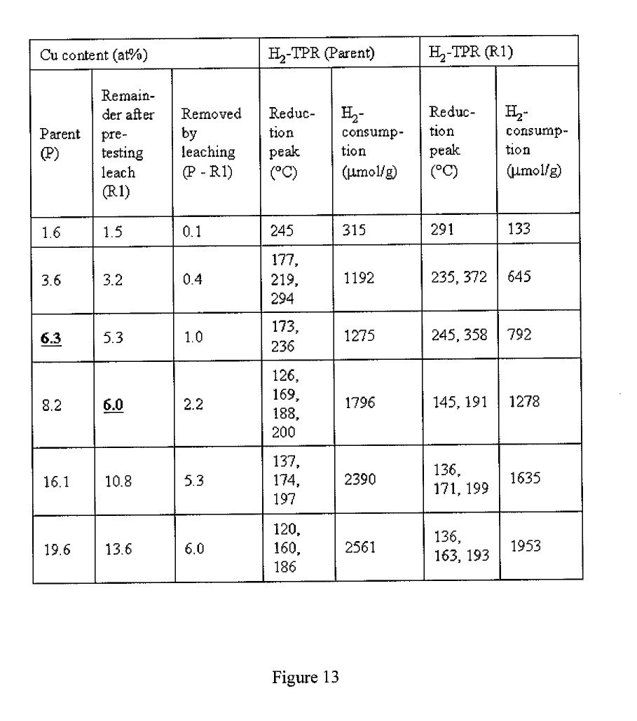

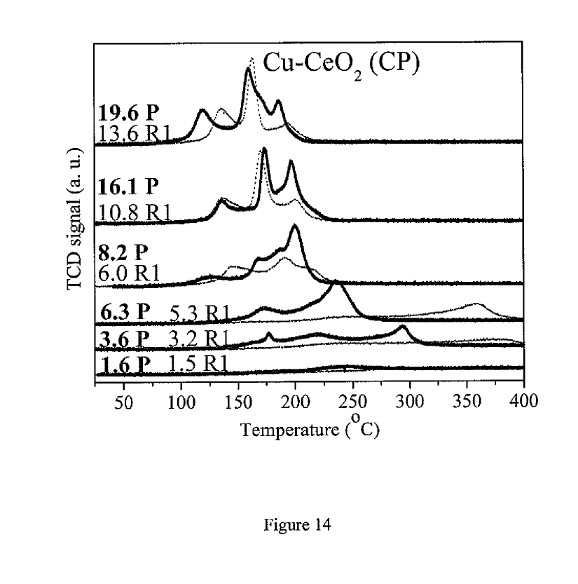

The H₂-TPR testing, conducted under dry conditions, shows multiple peaks for the parent (P) catalysts (FIG. 13) with the most prominent peak generally shifting to a lower temperature as the total copper content increases (FIG. 14). The catalysts remaining after the pre-testing leach (R1), however, exhibit multiple peaks only for Cu≧6% (remaining copper), but these peaks shift to lower temperatures as the Cu content increases as well (FIG. 14). Overall, the three highest copper contents (19.6, 16.1, and 8.2% parent and 13.6, 10,8, and 6.0% remaining after pre-testing leaching) are not affected greatly by the leaching process, but the lowest content samples significantly change (6.3, 3.6, and 1.6% P and 5.3, 3.2, and 1.5% R1).

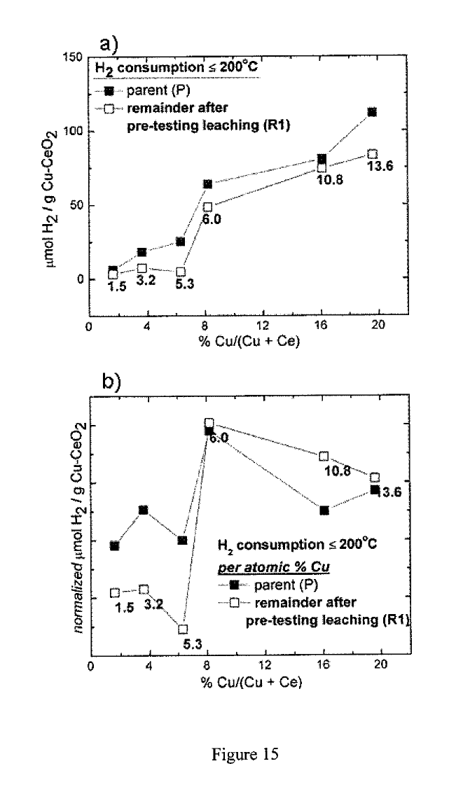

The total hydrogen consumed in the TPR experiments is considered only up to 200° C. (FIG. 15), because below the 300-400° C. operating range for a high temperature shift (HTS) (Sun, J.; Desjardins, J.; Buglass, J.; Liu, K., International Journal of Hydrogen Energy, 30(11), 1259-1264 (2005)) catalyst like copper-ceria (Qi, X.; Flytzani-Stephanopoulos, M., Industrial and Engineering Chemistry Research, 43, 3055-3062 (2004)), the reaction should be under kinetic rather than mass transfer control (Heck, R. M.; Farrauto, R. J., Catalytic air pollution control: commercial technology. 2nd ed.; Wiley-Interscience: New York (2002)). Not surprisingly, in FIG. 15a, the H₂-consumption increases with an increase in copper content. To determine an improved Cu/(Cu+Ce) ratio, the total consumption can be divided by the atomic percentage copper (FIG. 15b) in the parent (P) and pre-testing leach (R1) catalysts, where the R1 data are presented as a function of parent Cu content for clarity, with the actual copper content included next to the corresponding point. It is evident that the 8% P and 6% R1 Cu—CeO₂ samples exhibit improved performance per atomic % copper. Hereafter, such “per atomic % copper” values will be referred to as “normalized” by copper content

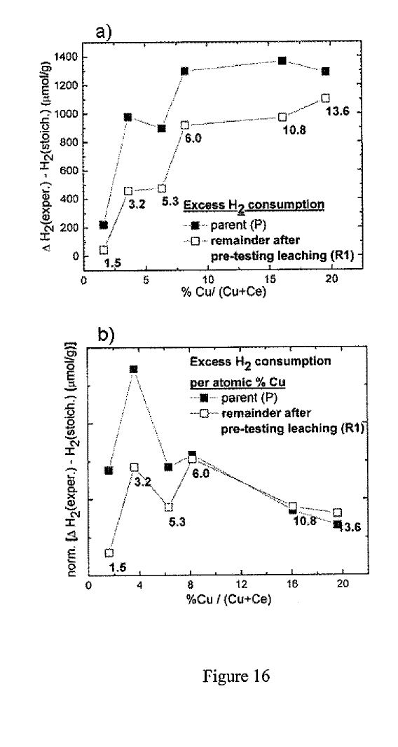

Moreover, knowing the amount of Cu in the catalysts, it is possible to calculate from stoichiometry how much H₂ should be consumed in reducing Cu²⁺ to Cu, where XANES data generally indicate that all the copper species initially exist as Cu²⁺ in the nanoparticles. The calculated amounts of H₂ can be compared to the actual amounts of H₂ consumed, over the entire temperature range studied, where the difference between experimental results and stoichiometry is plotted as a function of parent copper content. Here it is evident that the P and R1 samples, all display a significant hydrogen consumption above the amount expected based on the actual Cu²⁺ content and the magnitude of the excess consumption increases as the copper content increases (FIG. 16).

However, when this difference between the actual consumption and the expected consumption is normalized by the copper content and plotted as a function of parent copper content (FIG. 16b), it is clear that the greatest excess hydrogen consumption is again at an intermediate ratio of copper to ceria (3.6% parent and 3.2% remaining after pre-testing leaching).

In a similar manner to the TPR data discussed above, under WGS testing, the three highest Cu contents in the parent (P) catalysts exhibit the best CO conversion. These three contents, 19.6, 16.0, and 8.2% Cu—CeO₂, achieve approximately 90% conversion at 350° C. (FIG. 6), while the 6.3 and 3.6% parent catalysts both convert only about 45% of CO at 350° C. and the 1.6% barely achieves 10% conversion. The pre-testing leached catalysts show slightly depressed activity, but the same trend (FIG. 6b) as the parent catalysts with the three highest Cu-contents characterized by near identical behavior, but the three lowest Cu-contents exhibiting minimal conversion. Thus, there is a critical copper concentration of about 8% for the P and 6% for the R1 samples above which addition of copper does not improve activity.

The samples exhibiting the greatest difference between pre- and post-leaching results (FIG. 6c) correspond to the 6.3% P and 5.3% R1 samples with a 30% depression in conversion at 350° C. for the leached sample. The 19.6% Cu—CeO₂ sample is unaffected by the leaching process exhibiting near identical results after the removal of leachable copper. Generally, the three highest copper contents are affected very little by the leaching process in terms of activity, while the lowest contents are greatly affected.

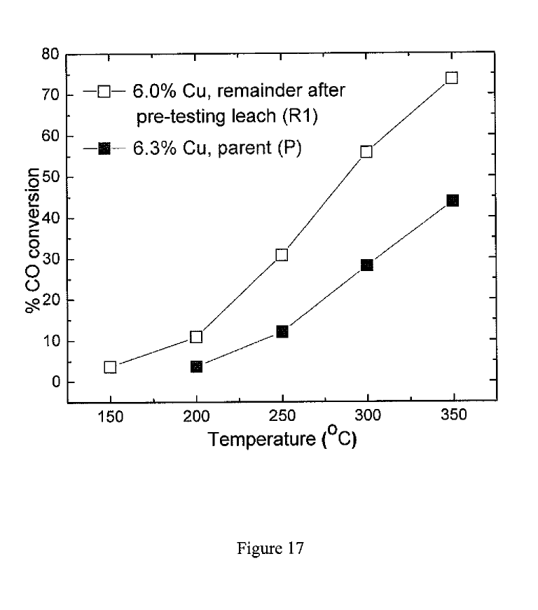

In FIG. 17, the WGS activities of the parent and post-leaching samples having almost identical copper contents of 6% are compared, where for the latter sample, the 6% copper (R1) remains after the pre-testing cyanide treatment of the 8.2% parent catalyst. It is evident that, although the parent has slightly more copper at 6.3% than the R1 sample at 6.0%, the former's activity is not as high.

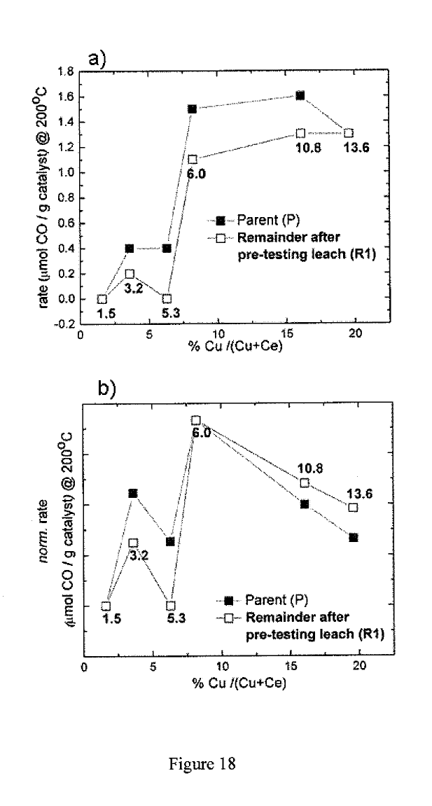

The final analysis of catalytic data involves the rate (μmol/g catalyst) of CO conversion in the WGS reaction at 200° C. This temperature was chosen for the same reason described in connection with FIG. 15. In FIG. 18, the parent (P) and pre-testing leach (R1) rate data are plotted at 200° C. As in previous diagrams, for ease of comparison, all data points are referenced to the original parent composition on the x-axis, but the actual composition is indicated next to the corresponding point. Not surprisingly, the parent catalysts exhibit the highest rate of conversion generally. Normalizing the rate from FIG. 18a by copper contents in the P and R1 catalysts yields the effective conversion rate per mole Cu (FIG. 18b). The 8% P and 6% R1 data show a particularly high rate per unit copper.

After TPR and WGS testing, select parent (P) and pre-testing leach (R1) catalysts with high copper contents (≧8% parent) were re-examined by XRD. As before testing, the only peaks visible were the characteristic peaks of cerium oxide.

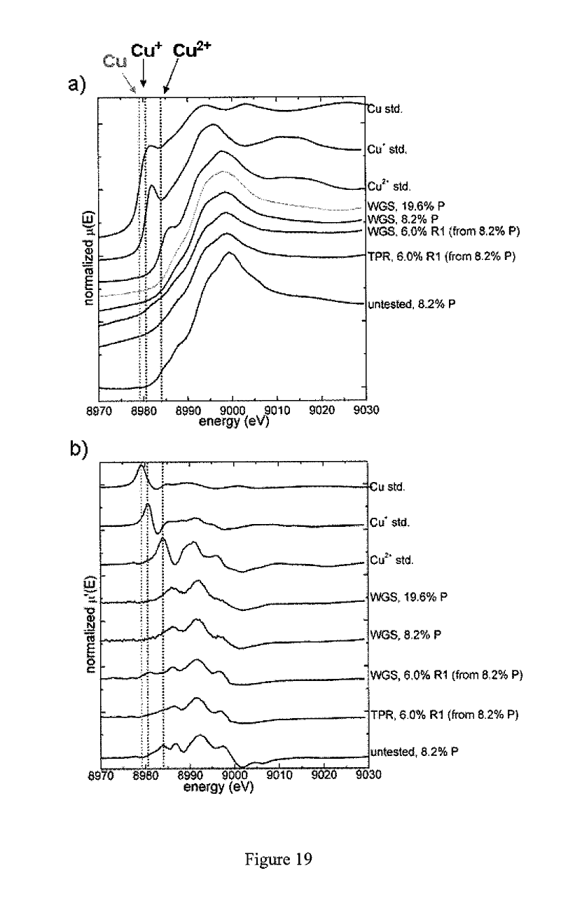

Similarly, according to XANES data, the oxidation state of copper after testing was generally unchanged. That is, the oxidation state is predominantly +2 after testing as it was prior to testing (FIG. 19). This determination was made by comparison of the catalyst samples to known oxidation state standards for copper (described above) in terms of the positions of the maxima in the first derivative (the absorption edge, Eₒ) and the line shape of the first derivative (Berry et al. (2006)). Unlike the other samples, in addition to Cu²⁺, the R1 samples studied showed a non-negligible Cu¹⁺ content after WGS testing.

The copper content remaining after leaching of used catalysts (designated as R2 hereafter) was consistently 2-3% as determined by ICP-AES (FIG. 20), although the testing (WGS or TPR) and the initial treatment of the catalyst varied.

### Discussion

The results presented above suggest that a complete solid solution of copper in the ceria lattice does not exist, because the lattice parameter remains fairly constant despite the addition of increasing amounts of copper. Therefore, given that XRD does not show any peaks associated with copper species (FIG. 10), some of the copper may be amorphous in nature or may exist in small clusters. The results of an electrochemical study (Knauth, P.; Schwitzgebel, G.; Tschope, A.; Villain, S., Journal of Solid State Chemistry, 140(2), 295-299 (1998)) suggest that the latter case, clustering or interfacial segregation, is an explanation for this phenomenon.

However, it appears probable that there is some solid solution formation, just limited in extent. First, the lattice parameters of all the samples are depressed with respect to that of bulk cerium oxide, which is shown as a dotted line in FIG. 12. Moreover, the lattice parameter of pure nano-ceria has been found to be larger (Zhang et al. (2002)) than that of bulk ceria, so the depression observed is likely larger in magnitude than it would appear, since these are nanoparticles. Second, the defective microstructure found in the nanoparticles is consistent with the inhomogeneous strain that would result from solid solution formation involving two cations of such different sizes as indicated above. Inhomogeneous strain is indicated by the size discrepancy found in the high-copper content samples, with XRD-based calculations providing a much smaller size than TEM-based calculations (FIG. 2). It is possible that the solid solution content is 2-3% Cu, the final copper content observed in the select nanoparticles that were leached after catalytic testing (FIG. 20). The rest of the copper could exist as clusters or interfacially segregated as described above.

From activity testing results, it is apparent that critical Cu contents exist for both the parent (between 6.3% and 8.2%) and pre-testing remainder (between 5.3% and 6.0%) samples. Above these critical regions, the catalysts are effective (FIGS. 5a and 5b, respectively), but show little improvement in conversion.

Moreover, by normalizing the rate of CO conversion (FIG. 18) and hydrogen consumption (FIG. 15) by the copper content in the parent (P) and pre-testing leach (R1) catalysts, it is also evident that there is another improved ratio of Cu/(Cu+Ce) to be considered. That is, these “per unit Cu” values at 200° C. were found to be the highest for the compositionally intermediate copper contents of 8.2% for the P and 6.0% for the R1 catalysts.

The same synergy is seen in FIG. 16 for the 3.6 P and 3.2 R1 catalysts. These improved values, while still in the middle of the composition range, are slightly different than found for the “per unit Cu” WGS conversion rate and hydrogen consumption at 200° C., discussed above. This difference between FIG. 16 and FIGS. 15 and 18 is not surprising. The calculation, graphically presented in FIG. 16, considers all the hydrogen consumed up to 400° C., at which temperature, mass transfer effects may be important (Heck et al. (2002)), but the other figures are based on data collected at 200° C. or lower.

In order to perform the calculation shown graphically in FIG. 16, it is necessary to assume that all the Cu²⁺ has been converted to Cu. Such an assumption is not fair at 200° C. and below where research on this nanoparticle system (Wang, X.; Rodriguez, J. A.; Hanson, J. C.; Gamarra, D.; Martinez-Arias, A.; Fernandez-Garcia, M., Journal of Physical Chemistry B, 109(42), 19595-19603 (2005)) has shown that the conversion of copper oxide to metallic copper is incomplete. Therefore the calculation was carried out at 400° C. where complete conversion is likely (Wang et al. (2005)). Moreover, even if conversion of Cu²⁺ to Cu is not entirely complete at 400° C., this only implies that the excess hydrogen consumption is due to cerium reduction (i.e., reduction of the catalyst support in addition to the active metal oxide, CuO) and that the synergy between copper and cerium oxide is greater.

These findings, that there are critical copper contents above which WGS conversion is not significantly enhanced and improved ratios of Cu/(Cu+Ce) for “per unit Cu” catalytic performance, are consistent with the literature. At high copper contents, other groups studying Cu—CeO₂ catalysts have found a depression in WGS activity in one study (Rodriguez, J. A.; Liu, P.; Hrbek, J.; Evans, J.; Perez, M., Angewandte Chemie, 46, 1329-1332 (2007)) and an increase in the light off temperature for NO conversion in another (Bera et al. (2002)). Similarly, catalytic research involving Pt—CeO₂ has shown that the removal of some platinum by NaCN leaching results in a decrease in the light-off temperature for the WGS reaction (Fu, Q.; Deng, W.; Saltsburg, H.; Flytzani-Stephanopoulos, M., Applied Catalysis B, 56 (2005), 57-68 (2005)).

Ultimately, the improved performance exhibited by these mid-composition copper content samples is a positive finding, since one objective in catalysis research is to minimize the input materials, especially expensive active metals, and hopefully can lead to greater understanding of other systems such as Pt—CeO₂, where the active metal is more costly.

The results of this study also show that the Cu—CeO₂ system is dynamic under water-gas shift, and in general, reducing conditions. The ability to leach a much greater percentage of copper from the samples post-catalytic testing than pre-catalytic testing, as seen in a comparison of FIGS. 8 and 20, suggests that copper either migrates to the surface or becomes more loosely bound during catalytic testing, where studies with Au have found only the loosely bound species, such as metallic Au, to be susceptible to cyanide leaching (Deng, W.; Carpenter, C.; Saltsburg, H.; Flytzani-Stephanopoulos, M. In Comparison of nanostructured Au—CeO₂ and Au—FeOₓ catalysts for the WGS and Co oxidation reactions, 2005 AIChE Annual Meeting and Fall Showcase, Cincinnati, Ohio, 2005; American Institute of Chemical Engineers: Cincinnati, Ohio, 9916 (2005)).

The dynamic nature of the system is further seen in the return of the catalytically tested parent (P) samples to the +2 state after testing (FIG. 19), although a partial reduction to copper metal during the WGS reaction has been seen in these samples with in situ XANES. A similar reduction to copper metal has been observed (Wang, X.; Rodriguez, J. A.; Hanson, J. C.; Gamarra, D.; Martinez-Arias, A.; Fernández-Garcia, M., Journal of Physical Chemistry B, 110, 428-434 (2006)), even when copper is supported on other materials, like molybdenum oxide (Wen, W.; Jing, L.; White, M. G.; Marinkovic, N.; Hanson, J. C.; Rodriguez, J. A., Catalysis Letters, 113(1-2), 1-6 (2007)). Moreover, this return to the +2 state occurs in spite of the fact that the samples are cooled in an inert atmosphere in TPR and a reducing atmosphere in WGS testing before being exposed to air, and so, are not exposed to an oxidizing atmosphere at an elevated temperature. Thus these Cu—CeO₂ nanoparticulate catalysts exhibit facile re-oxidation, which is likely the result of the CeO₂ support providing regenerating oxygen to the active copper.

The presence of a non-negligible Cu¹⁺ content in the post-testing leached samples (R2) which were also leached before testing (R1) may be explained by considering studies of pure CuO nanoparticles. Under reducing conditions, whereas bulk CuO converts directly to Cu metal when heated, nanoparticles exhibit a stable Cu₂O structure and the temperature range of Cu₂O stability is larger for 5 nm than 12 nm particles (Pike, Chan et al. (2006)). Moreover, a critical size has been determined below which cubic copper (I) oxide is more stable than monoclinic copper (II) oxide ((Palkar, V. R.; Ayyub, P.; Chattopadhyay, S.; Multani, M., Physical Review B (Condensed Matter), 53(5), 2167-70 (1996)), which is consistent with numerous studies that have found that higher-symmetry lattices are more stable as particle size decreases (Lu, C. H., Raitano, J. M., Khalid, S., Zhang, L., Chan, S.-W., Journal of Applied Physics, 103(12), 124303/1-7 (2008)).

With these properties of Cu₂O and CuO in mind, it is now possible to re-examine the Cu¹⁺ presence in the XANES spectra of the catalysts that were leached before and for after testing (FIG. 19). Following the pre-testing leach, the R1 catalysts are heated while undergoing WGS catalysis or TPR, and during such time, based on FIG. 20, it is likely that copper diffuses to the surface of the nanoparticles. It is probable that such copper species are better dispersed having had less residence time on the surface for thermal aggregation and growth (Palkar, V. R.; Ayyub, P.; Chattopadhyay, S.; Multani, M., Physical Review B (Condensed Matter), 53(5), 2167-2170 (1996)). Therefore, the copper species at the R1 surface are likely smaller clusters or nanoparticles. As such, they would exhibit an enhanced stability of the Cu₂O structure relative to larger species. The presence of smaller copper species and/or the presence of Cu¹⁺ cations on the R1 catalysts may help to explain FIG. 17, wherein a R1 catalyst with less copper content than a P (or parent) catalyst outperforms the P catalyst (6.0% Cu for R1 versus 6.3% Cu for P).

FIG. 16b, moreover, reinforces this idea that the pre-testing leached catalyst (R1) may exhibit better activity than the catalysts not leached before testing (P), but only if the initial copper content in the parent catalyst is sufficiently high. That is, in FIG. 16b, below 6% copper content in the R1 samples, the normalized hydrogen consumption is not as high as in the parent catalysts. However, when the R1 copper content exceeds 6%, the R1 catalysts begin to slightly exceed the parent.

This figure, 16b, was chosen to illustrate this point, because it considers excess hydrogen consumption (beyond that expected for complete conversion of CuO to Cu) at temperatures up to 400° C., the temperature at which significant amounts of copper in the R1 catalysts appear to have diffused to the surface of the nanoparticles (FIG. 20). Thus, the crossover that occurs in FIG. 16b at 6.0% R1 suggests that another critical copper content is exists for these samples, but that this critical value is likely related to the amount of copper/copper oxide that needs to be on the surface for the Cu—CeO₂ catalysts to be effective. If it is assumed that this 6% R1 catalyst has 2-3% copper in solid solution (i.e., “subsurface”, unleachable copper), like all the catalysts studied in FIG. 20, then the critical content for surface copper is likely about 3% (i.e., 6% R1-3% R2). Once this level of 3% surface copper content is met and exceeded, the leached catalysts, which have been inferred to have smaller surface copper clusters than the parent catalysts, outperform the parent.

The foregoing merely illustrates the principles of the disclosed subject matter. Various modifications and alterations to the described embodiments will be apparent to those skilled in the art in view of the teachings herein. Features of existing methods can be seamlessly integrated into the methods of the exemplary embodiments of the disclosed subject matter or a similar method. It will thus be appreciated that those skilled in the art will be able to devise numerous methods and compositions which, although not explicitly shown or described herein, embody the principles of the disclosed subject matter and are thus within its spirit and scope.

Various publications, patents, and patent applications are cited herein, including U.S. Pat. No. 7,141,227, the contents of all of which are hereby incorporated by reference in their entireties.

What is claimed is:

1. A method for producing nanoparticles, comprising:
a) combining a solution comprising cerium nitrate hexahydrate with a solution comprising hexamethylenetetramine (HMT) to form a combined aqueous solution;
b) combining said combined aqueous solution with a solution comprising copper nitrate trihydrate to form a further aqueous solution; and
c) mixing said further aqueous solution to produce nanoparticles.

2. The method of claim 1, wherein the nanoparticles comprise a high defect density.

3. The method of claim 1, further comprising collecting the nanoparticles from said further aqueous solution.

4. The method of claim 1, wherein said further aqueous solution is mixed for at least about 18 hours prior to collecting said nanoparticles.

5. The method of claim 1, further comprising heating said combined aqueous solution prior to combining with said solution comprising copper nitrate trihydrate.

6. The method of claim 5, wherein said combined aqueous solution is heated to approximately 40° C.

7. The method of claim 5, wherein after said solution comprising copper nitrate trihydrate is added, the further aqueous solution is heated for at least about three hours.

8. The method of claim 7, wherein after said about three hours, said heat is removed, and said further aqueous solution is mixed for at least about 18 hours.

9. (canceled)

10. (canceled)

11. The method of claim 1, wherein said cerium nitrate hexahydrate has a concentration of about 0.0375M.

12. The method of claim 1, wherein said hexamethylenetetramine has a concentration of about 0.5M.

13. The method of claim 1, wherein said copper nitrate trihydrate has a concentration of between about 0.004M and about 0.067M.

14. The method of claim 1, further comprising use of said nanoparticles as a catalyst in a redox reaction.

15. The method of claim 14, wherein said redox reaction comprises a water-gas shift reaction.

16. (canceled)

17. The method of claim 15, wherein said water-gas shift reaction occurs in a fuel cell.

18. The method of claim 1, further comprising use of said nanoparticles in a chemical mechanical planarization process.

19. A nanoparticle prepared by:
a) combining a solution comprising cerium nitrate hexahydrate with a solution comprising an hexamethylenetetramine (HMT) to form a combined aqueous solution;
b) combining said combined aqueous solution with a solution comprising copper nitrate trihydrate to form a further aqueous solution; and
c) mixing said further aqueous solution to produce a nanoparticle.

20. (canceled)

21. (canceled)

22. The nanoparticle of claim 19, wherein said cerium nitrate hexahydrate has a concentration of about 0.0375M.

23. The nanoparticle of claim 19, wherein said hexamethylenetetramine has a concentration of about 0.5M.

24. The nanoparticle of claim 19, wherein said copper nitrate trihydrate has a concentration of between about 0.004M and about 0.067M.

25. The nanoparticle of claim 19, wherein said nanoparticle has a copper content above about 8%.
